(19) United States
(12) Patent Application Publication
(10) Pub. No.: US 2013/0022833 A1
(43) Pub. Date: Jan. 24, 2013

(54) ELECTROMAGNETIC MACHINE AND SYSTEM INCLUDING SILICON STEEL SHEETS

(71) Applicant: Shekhar G. Wakade, Grand Blanc, MI (US)

(72) Inventor: Shekhar G. Wakade, Grand Blanc, MI (US)

(73) Assignee: GM GLOBAL TECHNOLOGY OPERATIONS LLC, Detroit, MI (US)

(21) Appl. No.: 13/188,750

(22) Filed: Jul. 22, 2011

(51) Int. Cl. H01F 1/047; C22C 38/12; C22C 38/14; B32B 15/18; C22C 38/00; C22C 38/42; C22C 38/34; C22C 38/06; C22C 38/02

(52) U.S. Cl. 428/611; 420/103; 420/118; 420/126; 420/127; 420/8; 420/91; 428/336; 428/426

(57) ABSTRACT

A silicon steel sheet formed from a silicon steel alloy composition includes, in parts by weight, iron, carbon present in an amount of from about 0.002 to about 0.06, silicon present in an amount of from about 1.5 to about 4.0, aluminum present in an amount of from about 0.1 to 1.0, titanium present in an amount of less than or equal to about 0.03, vanadium present in an amount of less than or equal to about 0.005, and cobalt present in an amount of from about 0.001 to about 5.0 based on 100 parts by weight of the composition. Neither niobium nor zirconium is present in the composition. A silicon steel sheet system including the silicon steel sheet and a coating disposed thereon, and an electromagnetic machine having a magnetic core including a plurality of sheets stacked adjacent one another are also disclosed.

### TECHNICAL FIELD

The present disclosure generally relates to electrical steel, and more specifically, to silicon steel sheet systems and electromagnetic machines including silicon steel sheets formed from a silicon steel alloy composition.

### BACKGROUND

Electromagnetic machines such as electric motors, generators, and traction motors are useful for converting one form of energy to another. For example, an electric motor may convert electrical energy to mechanical energy through the interaction of magnetic fields and current-carrying conductors. In contrast, a generator or dynamo may convert mechanical energy to electrical energy. Further, other electromagnetic machines such as traction motors for hybrid vehicles may operate as both an electric motor and/or a generator.

Electromagnetic machines often include an element rotatable about a central longitudinal axis. The rotatable element, i.e., a rotor, may be coaxial with a static element, i.e., a stator, and energy may be converted via relative rotation between the rotor and stator. Portions of the rotor and/or the stator may be formed from non-oriented silicon steel. Efficiency of such electromagnetic machines is often dependent upon minimizing iron losses and copper losses.

### SUMMARY

A silicon steel sheet is formed from a silicon steel alloy composition including iron, carbon present in an amount of from about 0.002 parts by weight to about 0.06 parts by weight based on 100 parts by weight of the silicon steel alloy composition, silicon present in an amount of from about 1.5 parts by weight to about 4.0 parts by weight based on 100 parts by weight of the silicon steel alloy composition, aluminum present in an amount of from about 0.1 parts by weight to about 1 part by weight based on 100 parts by weight of the silicon steel alloy composition, titanium present in an amount of less than or equal to about 0.03 parts by weight based on 100 parts by weight of the silicon steel alloy composition, vanadium present in an amount of less or equal to than about 0.005 parts by weight based on 100 parts by weight of the silicon steel alloy composition, and cobalt present in an amount of from about 0.001 parts by weight to about 5.0 parts by weight based on 100 parts by weight of the silicon steel alloy composition. Further, neither niobium nor zirconium is present in the silicon steel alloy composition.

A silicon steel sheet system includes the silicon steel sheet and a coating disposed on the silicon steel sheet.

An electromagnetic machine includes a magnetic core including a plurality of silicon steel sheets stacked adjacent one another, wherein each of the plurality of silicon steel sheets is formed from the silicon steel alloy composition.

The above features and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic cross-sectional illustration of a silicon steel sheet system including a silicon steel sheet formed from a silicon steel alloy composition; and

FIG. 2 is a schematic exploded perspective illustration of an electromagnetic machine including the silicon steel sheet of FIG. 1.

### DETAILED DESCRIPTION

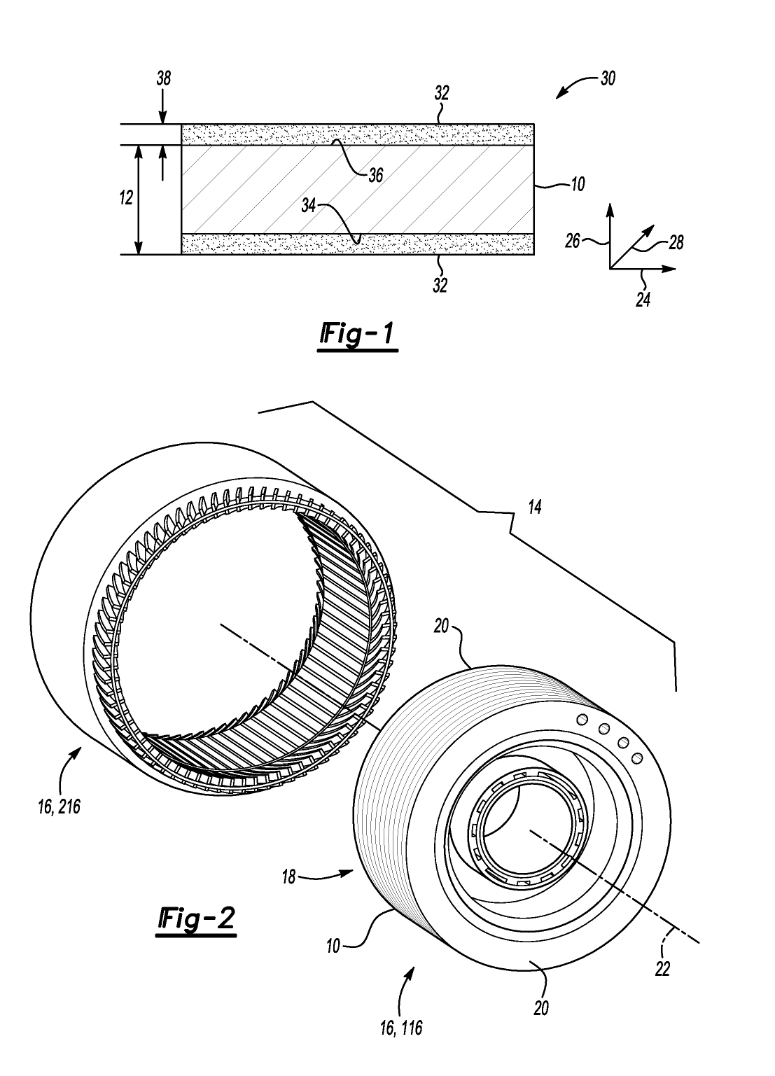

Referring to the Figures, wherein like reference numerals refer to like elements, a silicon steel sheet is shown generally at 10 in FIG. 1. The silicon steel sheet 10 may be useful for automotive applications requiring excellent magnetic properties, e.g., minimal hysteresis and magnetic core loss, and increased permeability and magnetic induction for a given thickness 12 of the silicon steel sheet 10. As such, the silicon steel sheet 10 may be useful for forming electromagnetic machines 14 (FIG. 2) such as, but not limited to, generators and motors, e.g., traction motors, for automotive vehicles powered by electricity. Although not shown, such automotive vehicles powered by electricity include, but are not limited to, hybrid electric vehicles, extended range electric vehicles, battery electric vehicles, and plug-in electric vehicles. Further, such automotive vehicles powered by electricity may include components such as, but not limited to, a battery (not shown) for energy storage, one or more electromagnetic machines 14 (FIG. 2) such as an electric motor for vehicle propulsion and/or a generator for generating electricity, a mechanical transmission (not shown), and a power control system (not shown). However, the silicon steel sheet 10 may also be useful for non-automotive applications including, but not limited to, components for aviation vehicles, construction vehicles, and recreational vehicles.

Referring now to FIG. 2, the electromagnetic machine 14 includes a magnetic component 16. The magnetic component 16 may be, for example, a rotor 116 or stator 216 and may rotate or remain stationary with respect to one or more other elements (not shown) of the electromagnetic machine 14. The magnetic component 16 includes a plurality of silicon steel sheets 10 stacked adjacent one another, wherein each of the plurality of silicon steel sheet 10 is formed from a silicon steel alloy composition, as set forth in more detail below.

By way of general explanation, the rotor 116, i.e., one type of magnetic component 16, is described generally with reference to FIG. 2. The rotor 116 may include a lamination stack 18 disposed between two end rings 20 along a central longitudinal axis 22 of the rotor 116. More specifically, the lamination stack 18 or core is generally formed from the plurality of silicon steel sheets 10 stacked adjacent one another axially along the central longitudinal axis 22. The plurality of silicon steel sheets 10 may also be referred to as, for example, steel laminations, silicon steel sheet, electrical steel sheet, lamination steel sheet, and/or transformer steel sheet. Therefore, as used herein, the terminology “silicon steel sheet 10” refers to a grade of steel, often including silicon, tailored to produce desired magnetic properties, e.g., low energy dissipation per cycle and/or high permeability, and suitable for carrying magnetic flux. For example, although not shown to scale in FIG. 1, the individual silicon steel sheets 10 may be die cut into circular layers or laminations having a thickness 12 of less than or equal to about 2 mm. The circular layers may then be stacked adjacent one another to form the lamination stack 18 (FIG. 2). That is, as shown in FIG. 2, the lamination stack 18 may be formed from cold-rolled strips of silicon steel sheet 10 stacked together to form an annular core of the rotor 116.

With continued reference to FIG. 2, the stator 216 may also have an annular shape, and may be configured to surround the rotor 116 during operation of the electromagnetic machine 14. Although not shown, it is to be appreciated that the stator 216 may also include a plurality of silicon steel sheets 10.

By way of general explanation, the electromagnetic machine 14 may function through relative rotation between the rotor 116 and the stator 216 about the central longitudinal axis 22. Further, although the rotor 116 is shown disposed within the stator 216 in FIG. 2, the stator 216 may alternatively be disposed within the rotor 116.

Referring again to FIG. 1, the silicon steel sheet 10 is formed from the silicon steel alloy composition. That is, the silicon steel sheet 10 is formed from a steel alloy.

### Fe, C

In particular, the silicon steel alloy composition includes iron. That is, the silicon steel alloy composition is ferrous, and as such, may exhibit magnetic properties. In addition, the silicon steel alloy composition includes carbon present in an amount of from about 0.002 parts by weight to about 0.06 parts by weight based on 100 parts by weight of the silicon steel alloy composition. The silicon steel alloy composition includes carbon in the aforementioned amount so that the silicon steel sheet 10 (FIG. 1) may be tailored to exhibit magnetic properties. Carbon may also increase the strength, e.g., tensile strength and yield strength, and wear-resistance of the silicon steel sheet 10.

However, carbon may also be characterized as an impurity in the silicon steel alloy composition. In particular, increased carbon may increase magnetic hysteresis, which may in turn increase magnetic core loss of the electromagnetic machine 14 (FIG. 2) including the silicon steel sheet 10. As used herein, the terminology “magnetic core loss” refers to a total energy lost through heat generation as the iron of the silicon steel alloy composition is repeatedly magnetized and demagnetized in a magnetic field. Magnetic core loss may be attributable to eddy currents and/or hysteresis. Eddy currents are small stray electrical currents that may be generated within the silicon steel sheet 10 disposed in the magnetic field. As current flows through the silicon steel sheet 10, heat is generated, and may contribute to inefficiency of the electromagnetic machine 14 including the silicon steel sheet 10. Further, as used herein, the terminology “hysteresis” is another form of heat loss attributable to expansion and contraction of magnetic domains of the silicon steel alloy composition that may also contribute to inefficiency of the electromagnetic machine 14.

Therefore, to minimize magnetic core loss from eddy currents and/or hysteresis, carbon may be present in the silicon steel alloy composition in an amount of, for example, from about 0.004 parts by weight to about 0.008 parts by weight based on 100 parts by weight of the silicon steel alloy composition. In one specific example, carbon may be present in the silicon steel alloy composition in about 0.006 parts by weight based on 100 parts by weight of the silicon steel alloy composition.

### Si

The silicon steel alloy composition also includes silicon present in an amount of from about 1.5 parts by weight to about 4.0 parts by weight based on 100 parts by weight of the silicon steel alloy composition. For example, silicon may be present in the silicon steel alloy composition in an amount of from about 2.0 parts by weight to about 3.5 parts by weight based on 100 parts by weight of the silicon steel alloy composition. Silicon may stabilize a ferrite component of the silicon steel alloy composition, wherein the ferrite component has a body centered cubic crystalline structure. In addition, silicon may act as a graphitizer and deoxidizer, and may increase the corrosion-resistance, strength, e.g., tensile strength and yield strength, electrical resistivity, and magnetic permeability of the silicon steel sheet 10 (FIG. 1). As used herein, the terminology “magnetic permeability” refers to an amount of magnetizing force that is required to achieve a given magnetic flux density. Therefore, magnetic permeability is a ratio of magnetic flux density to magnetic field strength. As magnetic permeability increases, less electrical energy, e.g., current flow, is required to achieve the given magnetic flux density. In turn, reduced electrical energy translates to reduced heat loss and operating costs, and increased efficiency of the electromagnetic machine 14 (FIG. 2). Therefore, in one specific example, silicon may be present in the silicon steel alloy composition in an amount of from about 2.5 parts by weight to about 3.5 parts by weight based on 100 parts by weight of the silicon steel alloy composition.

### Al

The silicon steel alloy composition also includes aluminum present in an amount of from about 0.1 parts by weight to about 1 part by weight based on 100 parts by weight of the silicon steel alloy composition. Aluminum may stabilize the ferrite component of the silicon steel alloy composition, may act as a graphetizer and deoxidizer within the silicon steel alloy composition, and may increase the corrosion-resistance and electrical resistivity of the silicon steel sheet 10 (FIG. 1). Therefore, magnetic core loss from eddy currents may decrease with increasing amounts of aluminum present in the silicon steel alloy composition. However, the alloying cost of the silicon steel alloy composition may increase as the amount of aluminum present in the silicon steel alloy composition increases, and operating efficiency of the electromagnetic machine 14 (FIG. 2) including the silicon steel sheet 10 may decrease due to a decrease in saturation magnetization. As used herein, the terminology “saturation magnetization” refers to a condition of the silicon steel sheet 10 reached when an increase in an applied magnetic field cannot further increase the magnetization of the silicon steel sheet 10. Further, for embodiments including aluminum present in the silicon steel alloy composition at greater than about 1 part by weight, if silicon and aluminum are present in a combined total of greater than about 4 parts by weight based on 100 parts by weight of the silicon steel alloy composition, processability of the silicon steel sheet 10, e.g., rollability and/or punchability of the silicon steel sheet 10, may be detrimentally affected. In one non-limiting example, the silicon steel alloy composition may include aluminum in an amount of from about 0.4 parts by weight to about 0.55 parts by weight based on 100 parts by weight of the silicon steel alloy composition.

### Ti

The silicon steel alloy composition also includes titanium present in an amount of less than or equal to about 0.03 parts by weight based on 100 parts by weight of the silicon steel alloy composition. Although titanium may form carbides in the silicon steel alloy composition and thereby increase a hardness, corrosion-resistance, and strength, e.g., tensile strength and yield strength, of the silicon steel sheet 10 (FIG. 1), titanium may only be present, if at all, in the silicon steel alloy composition in trace amounts. For example, titanium may be present in the silicon steel alloy composition in an amount of less than or equal to about 0.02 parts by weight based on 100 parts by weight of the silicon steel alloy composition.

### V

Similarly, the silicon steel alloy composition also includes vanadium present in an amount of less than or equal to about 0.005 parts by weight based on 100 parts by weight of the silicon steel alloy composition. Vanadium may stabilize the ferrite component of the silicon steel alloy composition and contribute to carbide formation within the silicon steel alloy composition. Vanadium may also increase the hardness, strength, e.g., tensile strength and yield strength, creep-resistance, and impact strength of the silicon steel sheet 10 (FIG. 1). However, vanadium may only be present, if at all, in the silicon steel alloy composition in trace amounts. For example, vanadium may be present in the silicon steel alloy composition in an amount of less than or equal to about 0.002 parts by weight based on 100 parts by weight of the silicon steel alloy composition.

### Nb, Zr

Neither niobium nor zirconium is present in the silicon steel alloy composition. That is, the silicon steel alloy composition is free from both niobium and zirconium. Stated differently, the silicon steel alloy composition includes no niobium and no zirconium, i.e., zero parts by weight niobium and zero parts by weight zirconium based on 100 parts by weight of the silicon steel alloy composition. That is, since niobium and zirconium generally significantly increase mechanical properties of a comparative silicon steel sheet (not shown) and detrimentally affect core losses of any comparative electromagnetic machine (not shown) that includes the comparative silicon steel sheet, the silicon steel alloy composition of the present disclosure is free from both niobium and zirconium.

### Co

The silicon steel alloy composition further includes cobalt present in an amount of from about 0.001 parts by weight to about 5.0 parts by weight based on 100 parts by weight of the silicon steel alloy composition. Without intending to be limited by theory, cobalt may stabilize an austenite component of the silicon steel sheet 10 (FIG. 1), wherein the austenite component has a face centered cubic crystalline structure. Further, although cobalt may decrease a hardenability of the silicon steel sheet 10 during formation, cobalt may act as a graphetizer within the silicon steel alloy composition. Cobalt may also increase the strength, e.g., tensile strength and yield strength, electrical resistivity, and magnetic permeability of the silicon steel sheet 10. In addition, cobalt may provide the silicon steel sheet 10 formed from the silicon steel alloy composition with minimal magnetic core loss and increased magnetic induction. Therefore, since the silicon steel alloy composition includes both silicon and cobalt, the electromagnetic machine 14 including the silicon steel sheet 10 exhibits minimal core losses and excellent magnetic flux density so that comparatively high induction can be achieved.

As such, cobalt is present in the silicon steel alloy composition in an amount of greater than or equal to about 0.001 parts by weight. However, since cobalt may increase an alloying cost of the silicon steel alloy composition, cobalt is present in an amount of less than or equal to about 5.0 parts by weight based on 100 parts by weight of the silicon steel alloy composition. In one non-limiting example, the silicon steel alloy composition includes cobalt present in an amount of from about 0.01 parts by weight to about 3.5 parts by weight based on 100 parts by weight of the silicon steel alloy composition.

### Mn

The silicon steel alloy composition may also include manganese present in an amount of from about 0.030 parts by weight to about 0.600 parts by weight based on 100 parts by weight of the silicon steel alloy composition. Manganese within the silicon steel alloy composition may stabilize the austenite component of the silicon steel alloy composition, may act as a deoxidizer, and may increase hardenability, strength, e.g., tensile strength and yield strength, wear-resistance, and electrical resistivity of the silicon steel sheet 10 (FIG. 1). Therefore, magnetic core loss from eddy currents may decrease with increasing amounts of manganese present in the silicon steel alloy composition. In one non-limiting example, the silicon steel alloy composition may include manganese present in an amount of from about 0.03 parts by weight to about 0.5 parts by weight based on 100 parts by weight of the silicon steel alloy composition.

Further, the silicon steel alloy composition may include phosphorus present in an amount of from about 0.002 parts by weight to about 0.020 parts by weight based on 100 parts by weight of the silicon steel alloy composition. Phosphorus may increase the corrosion-resistance and strength, e.g., tensile strength and yield strength, of the silicon steel sheet 10 (FIG. 1). However, at phosphorus amounts greater than about 0.020 parts by weight based on 100 parts by weight of the silicon steel alloy composition, the silicon steel sheet 10 may crack or break during formation. Therefore, by way of a non-limiting example, phosphorus may be present in the silicon steel alloy composition in an amount of about 0.01 parts by weight based on 100 parts by weight of the silicon steel alloy composition.

### Ni

In addition, the silicon steel alloy composition may also include nickel present in an amount of from about 0.002 parts by weight to about 0.060 parts by weight based on 100 parts by weight of the silicon steel alloy composition. Nickel may stabilize the austenite component of the silicon steel alloy composition and may act as a deoxidizer within the silicon steel alloy composition. Further, nickel may increase the tensile strength, yield strength, toughness, impact strength, and electrical resistivity of the silicon steel sheet 10 (FIG. 1). Therefore, magnetic core loss from eddy currents may decrease with increasing amounts of nickel present in the silicon steel alloy composition. Nickel may also minimize recystallization of the silicon steel alloy composition. However, nickel present in an amount of greater than about 0.060 parts by weight may contribute to breakage of the silicon steel sheet 10 during formation. As such, by way of a non-limiting example, nickel may be present in the silicon steel alloy composition in an amount of about 0.05 parts by weight based on 100 parts by weight of the silicon steel alloy composition.

### Cr

Further, the silicon steel alloy composition may also include chromium present in an amount of from about 0.006 parts by weight to about 0.090 parts by weight based on 100 parts by weight of the silicon steel alloy composition. Chromium may stabilize the ferrite component of the silicon steel alloy composition, and may contribute to carbide formation within the silicon steel alloy composition. As such, chromium may increase the hardness of the silicon steel sheet 10 (FIG. 1). In addition, chromium may increase the corrosion resistance, hardenability, strength, e.g., tensile strength and yield strength, and wear-resistance of the silicon steel sheet 10. Further, chromium may increase the electrical resistivity of the silicon steel sheet 10. Therefore, magnetic core loss from eddy currents may decrease with increasing amounts of chromium present in the silicon steel alloy composition. By way of a non-limiting example, chromium may be present in the silicon steel alloy composition in an amount of about 0.03 parts by weight based on 100 parts by weight of the silicon steel alloy composition.

### Mo

The silicon steel alloy composition may also include molybdenum present in an amount of from about 0.003 parts by weight to about 0.015 parts by weight based on 100 parts by weight of the silicon steel alloy composition. Molybdenum may stabilize the ferrite component of the silicon steel alloy composition, and may contribute to carbide formation within the silicon steel alloy composition. As such, molybdenum may increase the hardness of the silicon steel sheet 10 (FIG. 1). In addition, molybdenum may increase the hardenability, strength, e.g., tensile strength and yield strength, and electrical resistivity of the silicon steel sheet 10. Therefore, magnetic core loss from eddy currents may decrease with increasing amounts of molybdenum present in the silicon steel alloy composition. However, molybdenum present in an amount of greater than about 0.015 parts by weight may contribute to breakage of the silicon steel sheet 10 during formation. By way of a non-limiting example, molybdenum may be present in the silicon steel alloy composition in an amount of about 0.005 parts by weight based on 100 parts by weight of the silicon steel alloy composition.

### Cu

Additionally, the silicon steel alloy composition may include copper present in an amount of from about 0.003 parts by weight to about 0.09 parts by weight based on 100 parts by weight of the silicon steel alloy composition. Copper may stabilize the austenite component of the silicon steel alloy composition, and may increase the corrosion-resistance, strength, e.g., tensile strength and yield strength, and electrical resistivity of the silicon steel alloy composition. As such, magnetic core loss from eddy currents may decrease with increasing amounts of copper present in the silicon steel alloy composition. However, copper present in an amount of greater than about 0.09 parts by weight may contribute to surface flaws of the silicon steel sheet 10 (FIG. 1) and/or breakage of the silicon steel sheet 10 during formation. Therefore, in one non-limiting example, copper may be present in the silicon steel alloy composition in an amount of from about 0.003 parts by weight to about 0.02 parts by weight based on 100 parts by weight of the silicon steel alloy composition.

### Sn

The silicon steel alloy composition may also include tin present in an amount of from about 0.001 parts by weight to about 0.050 parts by weight based on 100 parts by weight of the silicon steel alloy composition. Tin may increase the corrosion-resistance of the silicon steel sheet 10 (FIG. 1). Tin may also minimize recrystallization of the silicon steel alloy composition during formation of the silicon steel sheet 10. In one non-limiting example, tin may be present in the silicon steel alloy composition in an amount of from about 0.003 parts by weight to about 0.050 parts by weight based on 100 parts by weight of the silicon steel alloy composition.

### B

Further, the silicon steel alloy composition may include boron present in an amount of from about 0.0001 parts by weight to about 0.004 parts by weight based on 100 parts by weight of the silicon steel alloy composition. Boron, in combination with nickel as set forth above, may increase magnetic properties of the silicon steel sheet 10, and may improve surface conditions of the silicon steel sheet 10 during annealing at a temperature of greater than or equal to about 800° C. As such, at less than 0.0001 parts by weight boron or at more than 0.004 parts by weight boron, the silicon steel sheet 10 formed from the silicon steel alloy composition may not exhibit sufficient magnetic properties. In one non-limiting example, boron may be present in the silicon steel alloy composition in an amount of about 0.0002 parts by weight based on 100 parts by weight of the silicon steel alloy composition.

### W

The silicon steel alloy composition may also include tungsten present in an amount of less than or equal to about 0.001 parts by weight based on 100 parts by weight of the silicon steel alloy composition. Tungsten may stabilize the ferrite component of the silicon steel alloy composition and may contribute to carbide formation with the silicon steel alloy composition. As such, tungsten may increase the hardness, tensile strength, and yield strength of the silicon steel sheet 10 (FIG. 1). In one specific non-limiting example, tungsten may be present in the silicon steel alloy composition in an amount of about 0.001 parts by weight based on 100 parts by weight of the silicon steel alloy composition.

### S

Further, for the silicon steel alloy composition, sulfur may be present in an amount of from about 0.002 parts by weight to about 0.009 parts by weight based on 100 parts by weight of the silicon steel alloy composition. Sulfur may be considered an impurity in the silicon steel alloy composition, and, as such, the amount of sulfur may be minimized within the silicon steel alloy composition. Further, forming costs of the silicon steel sheet 10 may increase by reducing the amount of sulfur present in the silicon steel alloy composition. Therefore, in one non-limiting example, sulfur may be present in the silicon steel alloy composition in an amount of about 0.005 parts by weight based on 100 parts by weight of the silicon steel alloy composition.

### O

The silicon steel alloy composition may also include oxygen present in an amount of from about 0.001 parts by weight to about 0.040 parts by weight based on 100 parts by weight of the silicon steel alloy composition. Oxygen may be considered as an impurity in the silicon steel alloy composition. By way of a non-limiting example, oxygen may be present in the silicon steel alloy composition in an amount of about 0.01 parts by weight based on 100 parts by weight of the silicon steel alloy composition.

### N

In addition, the silicon steel alloy composition may also include nitrogen present in an amount of from about 0.002 parts by weight to about 0.010 parts by weight based on 100 parts by weight of the silicon steel alloy composition. Nitrogen may be considered an impurity in the silicon steel alloy composition as it may contribute to nitride formation within the silicon steel alloy composition, and as such, may increase the hardness of the silicon steel sheet 10 (FIG. 1). Further, nitrogen may increase the creep-resistance of the silicon steel sheet 10. In one non-limiting example, nitrogen may be present in the silicon steel alloy composition in an amount of about 0.003 parts by weight based on 100 parts by weight of the silicon steel alloy composition.

Referring again to FIG. 1, the silicon steel sheet 10 may be further defined as non-oriented silicon steel sheet. As used herein, the terminology “non-oriented silicon steel sheet” refers to silicon steel sheet 10 having similar magnetic properties in the x-axis and y-axis directions, represented generally by 24 and 26 respectively in FIG. 1. For reference, the z-axis direction is also indicated at 28 in FIG. 1. That is, the non-oriented silicon steel sheet 10 may be isotropic. Such non-oriented silicon steel sheet 10 may be useful for applications wherein a direction of magnetic flux changes during operation of the electromagnetic machine 14 (FIG. 2).

Alternatively, the silicon steel sheet 10 (FIG. 1) may be further defined as grain-ordered silicon steel sheet. As used herein, the terminology “grain-ordered silicon steel sheet” refers to silicon steel sheet 10 having optimal magnetic properties in one direction, e.g., in a rolling direction of the silicon steel sheet 10. Such grain-ordered silicon steel sheet 10 may be useful for applications requiring excellent efficiency, e.g., high-efficiency traction motors.

The silicon steel sheet 10 may be formed by any suitable method. For example, the silicon steel sheet 10 may be formed by hot rolling or cold rolling. In addition, the silicon steel sheet 10 may be annealed and/or stress-relieved and may be fully-processed or semi-processed. Referring again to FIG. 1, after forming, the silicon steel sheet 10 may have a thickness 12 of from about 0.2 mm to about 0.65 mm. That is, the silicon steel sheet 10 may have a thickness 12 of from about 0.315 mm to about 0.385 mm, e.g., about 0.35 mm.

With continued reference to FIG. 1, a silicon steel sheet system is shown generally at 30. The silicon steel sheet system 30 includes the silicon steel sheet 10 and a coating 32 disposed on the silicon steel sheet 10. The coating 32 may encapsulate the silicon steel sheet 10, and may be disposed on at least two surfaces 34, 36 of the silicon steel sheet 10. Further, the coating 32 may have a thickness 38 of from about 0.2 microns to about 0.5 microns, wherein 1 micron is equal to 1×10⁻⁶ m. As such, the coating 32 may be a lamination, and may be any suitable organic or inorganic coating. The coating 32 may be selected according to the desired application of the silicon steel sheet 10, and may be classified as, for example, an A-coating, N-coating, D-coating, J-coating, oxide coating, enamel coating, and/or varnish coating. In general, the coating 32 may increase corrosion- and wear-resistance of the silicon steel sheet 10, and may decrease magnetic core loss by insulating against eddy currents.

Therefore, the silicon steel sheet 10 (FIG. 1) exhibits excellent magnetic induction and minimal magnetic core loss. In particular, the silicon steel alloy composition including cobalt increases the magnetic induction of the iron present in the silicon steel alloy composition, and contributes to the excellent magnetic induction and minimal magnetic core loss of the silicon steel sheet 10. Further, the electromagnetic machine 14 (FIG. 2) including a plurality of silicon steel sheets 10 exhibits high-efficiency during operation for a desired thickness 12 (FIG. 1) of the silicon steel sheet 10. As such, the silicon steel sheet 10, system 30 (FIG. 1), and electromagnetic machine 14 may be particularly useful for traction motors for electrically-powered automotive vehicles.

The following examples are meant to illustrate the disclosure and are not to be viewed in any way as limiting to the scope of the disclosure.

### EXAMPLES

Silicon steel sheets of Example 1 and Comparative Example 2 are formed from the respective silicon steel alloy compositions listed in Table 1. Each of the silicon steel sheets of Example 1 and Comparative Example 2 is annealed at 800° C. for 10 hours, and subsequently cold-rolled to a thickness of 0.35 mm.

TABLE 1
Silicon steel alloy compositions

| | Ex. 1 | Comp. Ex. 2 |
|---|---|---|
| Element | (parts by weight) | (parts by weight) |
| Carbon | 0.006 | 0.006 |
| Silicon | 3.0 | 3.0 |
| Aluminum | 0.5 | 0.5 |
| Titanium | 0.02 | 0.02 |
| Vanadium | 0.002 | 0.002 |
| Cobalt | 3.5 | — |
| Niobium | — | 0.1 |
| Zirconium | — | 0.1 |
| Manganese | 0.1 | 0.1 |
| Phosphorus | 0.01 | 0.01 |
| Nickel | 0.03 | 0.03 |
| Chromium | 0.008 | 0.008 |
| Molybdenum | 0.006 | 0.006 |
| Copper | 0.005 | 0.005 |
| Tin | 0.01 | 0.01 |
| Boron | 0.001 | 0.001 |
| Tungsten | 0.001 | 0.001 |
| Sulfur | 0.004 | 0.004 |
| Oxygen | 0.002 | 0.002 |
| Nitrogen | 0.003 | 0.003 |
| Iron | Balance | Balance |
| Total | 100 | 100 |

Each of the silicon steel sheets of Example 1 and Comparative Example 2 has two sides spaced opposite from one another, and is coated with a phosphate-based inorganic D-coating commercially available from JFE Steel Corporation of Tokyo, Japan, at a coating thickness of 0.4 microns per side to form a respective silicon steel sheet system of Example 1 and Comparative Example 2.

Magnetic properties of each of the silicon steel sheet systems of Example 1 and Comparative Example 2 are evaluated in accordance with Japanese Industrial Standard test method JIS C2550:2000, and are designated as acceptable or unacceptable according to the criteria set forth in Table 2. Similarly, mechanical properties of each of the silicon steel sheet systems of Example 1 and Comparative Example 2 are evaluated in accordance with Japanese Industrial Standard test method No. 5, and are designated as acceptable or unacceptable according to the criteria set forth in Table 3.

TABLE 2
Acceptable Magnetic Property Values for Silicon Steel Sheet Systems

| Magnetic Property | Acceptable Values | Ex. 1 | Comp. Ex. 2 |
|---|---|---|---|
| Magnetic induction | from about 1.68 T | Acceptable | Unacceptable |
| | to about 1.75 T | | |
| | at 5,000 A/m | | |
| Magnetic induction | from about 1.81 T | Acceptable | Unacceptable |
| | to about 1.90 T at | | |
| | 10,000 A/m | | |
| Magnetic core loss | from about 2.0 | Acceptable | Unacceptable |
| | W/kg to about 2.5 | | |
| | W/kg at 1.5 T and | | |
| | 50 Hz | | |
| Magnetic core loss | from about | Acceptable | Unacceptable |
| | 16 W/kg to | | |
| | about 20 W/kg at | | |
| | 1.0 T and 400 Hz | | |

TABLE 3
Acceptable Mechanical Property Values for Silicon Steel Sheet Systems

| Magnetic | | | |
|---|---|---|---|
| Property | Acceptable Values | Ex. 1 | Comp. Ex. 2 |
| Ultimate tensile | from about 450 MPa to | Acceptable | Unacceptable |
| strength | about 550 MPa | | |
| Yield strength | from about 325 MPa to | Acceptable | Unacceptable |
| | about 425 MPa | | |

Referring to Table 1, the silicon steel alloy composition and resulting silicon steel sheet system of Example 1 include cobalt, and do not include niobium or zirconium. In contrast, the silicon steel alloy composition and resulting silicon steel sheet system of Comparative Example 2 do not include cobalt, but include niobium and zirconium.

As shown by the results listed in Table 2, the silicon steel sheet system of Example 1 has a magnetic induction of from about 1.68 T to about 1.75 T at 5,000 A/m, and from about 1.81 T to about 1.90 T at 10,000 A/m, as measured in accordance with Japanese Industrial Standard test method JIS C2550:2000. In addition, the silicon steel sheet system of Example 1 has a magnetic core loss of from about 2.0 W/kg to about 2.5 W/kg at 1.5 T and 50 Hz, and from about 16 W/kg to about 20 W/kg at 1.0 T and 400 Hz, as measured in accordance with Japanese Industrial Standard test method JIS C2550:2000. In contrast, the silicon steel sheet system of Comparative Example 2, which does not include cobalt, has an unacceptable magnetic induction, i.e., a magnetic induction outside of the acceptable value range specified in Table 2.

Further, the silicon steel sheet system of Example 1 has an ultimate tensile strength of from about 450 MPa to about 550 MPa as measured in accordance with Japanese Industrial Standard test method No. 5. In contrast, the silicon steel sheet system of Comparative Example 2, which does not include cobalt, has an unacceptable ultimate tensile strength, i.e., an ultimate tensile strength outside of the acceptable value range specified in Table 3. Moreover, the silicon steel sheet system of Example 1 has a yield strength of from about 325 MPa to about 425 MPa as measured in accordance with Japanese Industrial Standard test method No. 5. In contrast, the silicon steel sheet system of Comparative Example 2 has an unacceptable yield strength, i.e., a yield strength outside of the acceptable value range specified in Table 3.

Without intending to be limited by theory, the cobalt of the silicon steel alloy composition of Example 1 stabilizes an austenite component of the silicon steel sheet of Example 1. Further, cobalt acts as a graphetizer within the silicon steel alloy composition and therefore increases the strength, e.g., tensile strength and yield strength and magnetic permeability of the silicon steel sheet 10 of Example 1. In addition, cobalt provides the silicon steel sheet formed from the silicon steel alloy composition of Example 1 with minimal magnetic core loss and increased magnetic induction. Therefore, since the silicon steel alloy composition of Example 1 includes both silicon and cobalt as set forth in Table 1, an electromagnetic machine, such as a hybrid traction motor, including the silicon steel sheet of Example 1 exhibits minimal core losses and excellent magnetic flux density so that desired high induction can be achieved.

Additionally, neither niobium nor zirconium is present in the silicon steel alloy composition of Example 1. That is, the silicon steel alloy composition of Example 1 is free from both niobium and zirconium. In contrast, the silicon steel alloy composition of Comparative Example 2 includes both niobium and zirconium, as set forth in Table 1. Without intending to be limited by theory, as shown by comparing the results listed in Tables 2 and 3, the presence of niobium and zirconium generally significantly increases the mechanical properties of the silicon steel sheet of Comparative Example 2, and detrimentally affects core losses of the silicon steel sheet of Comparative Example 2. In contrast, the silicon steel alloy composition of Example 1 is free from both niobium and zirconium and exhibits acceptable magnetic and mechanical properties.

While the best modes for carrying out the disclosure have been described in detail, those familiar with the art to which this disclosure relates will recognize various alternative designs and embodiments for practicing the disclosure within the scope of the appended claims.

1. A silicon steel sheet formed from a silicon steel alloy composition comprising:
iron;
carbon present in an amount of from about 0.002 parts by weight to about 0.06 parts by weight based on 100 parts by weight of the silicon steel alloy composition;
silicon present in an amount of from about 1.5 parts by weight to about 4.0 parts by weight based on 100 parts by weight of the silicon steel alloy composition;
aluminum present in an amount of from about 0.1 parts by weight to about 1.0 part by weight based on 100 parts by weight of the silicon steel alloy composition;
titanium present in an amount of less than or equal to about 0.03 parts by weight based on 100 parts by weight of the silicon steel alloy composition;
vanadium present in an amount of less than or equal to about 0.005 parts by weight based on 100 parts by weight of the silicon steel alloy composition; and
cobalt present in an amount of from about 0.001 parts by weight to about 5.0 parts by weight based on 100 parts by weight of the silicon steel alloy composition;
wherein neither niobium nor zirconium is present in the silicon steel alloy composition.

2. The silicon steel sheet of claim 1, wherein the silicon steel alloy composition includes cobalt present in an amount of from about 0.01 parts by weight to about 3.5 parts by weight based on 100 parts by weight of the electrical steel alloy composition.

3. The silicon steel sheet of claim 1, wherein the silicon steel alloy composition includes titanium present in an amount of less than or equal to about 0.02 parts by weight based on 100 parts by weight of the silicon steel alloy composition.

4. The silicon steel sheet of claim 2, wherein the silicon steel alloy composition includes vanadium present in an amount of from less than or equal to about 0.002 parts by weight based on 100 parts by weight of the silicon steel alloy composition.

5. The silicon steel sheet of claim 1, wherein the silicon steel alloy composition further includes manganese present in an amount of from about 0.030 parts by weight to about 0.600 parts by weight based on 100 parts by weight of the silicon steel alloy composition.

6. The silicon steel sheet of claim 1, wherein the silicon steel alloy composition further includes phosphorus present in an amount of from about 0.002 parts by weight to about 0.020 parts by weight based on 100 parts by weight of the silicon steel alloy composition.

7. The silicon steel sheet of claim 1, wherein the silicon steel sheet is further defined as non-oriented silicon steel sheet.

8. The silicon steel sheet of claim 1, wherein the silicon steel sheet is further defined as grain-ordered silicon steel sheet.

9. The silicon steel sheet of claim 1, having a thickness of from about 0.2 mm to about 0.65 mm.

10. The silicon steel sheet of claim 1, having a thickness of from about 0.315 mm to about 0.385 mm.

11. The silicon steel sheet of claim 1, wherein the silicon steel alloy composition further includes;
titanium present in an amount of less than or equal to about 0.02 parts by weight based on 100 parts by weight of the silicon steel alloy composition;
vanadium present in an amount of less than or equal to about 0.002 parts by weight based on 100 parts by weight of the silicon steel alloy composition;
aluminum present in an amount of from about 0.4 parts by weight to about 0.55 parts by weight based on 100 parts by weight of the silicon steel alloy composition;
manganese present in an amount of from about 0.030 parts by weight to about 0.600 parts by weight based on 100 parts by weight of the silicon steel alloy composition;
phosphorus present in an amount of from about 0.002 parts by weight to about 0.020 parts by weight based on 100 parts by weight of the silicon steel alloy composition;
nickel present in an amount of from about 0.002 parts by weight to about 0.060 parts by weight based on 100 parts by weight of the silicon steel alloy composition;
chromium present in an amount of from about 0.006 parts by weight to about 0.090 parts by weight based on 100 parts by weight of the silicon steel alloy composition;
molybdenum present in an amount of from about 0.003 parts by weight to about 0.015 parts by weight based on 100 parts by weight of the silicon steel alloy composition;
copper present in an amount of from about 0.003 parts by weight to about 0.09 parts by weight based on 100 parts by weight of the silicon steel alloy composition;
tin present in an amount of from about 0.001 parts by weight to about 0.050 parts by weight based on 100 parts by weight of the silicon steel alloy composition;
boron present in an amount of from about 0.0001 parts by weight to about 0.004 parts by weight based on 100 parts by weight of the silicon steel alloy composition; and
tungsten present in an amount of less than or equal to about 0.001 parts by weight based on 100 parts by weight of the silicon steel alloy composition.

12. The silicon steel sheet of claim 1, wherein the silicon steel alloy composition further includes;
carbon present in an amount of from about 0.004 parts by weight to about 0.008 parts by weight based on 100 parts by weight of the silicon steel alloy composition;
silicon present in an amount of from about 2.0 parts by weight to about 3.5 parts by weight based on 100 parts by weight of the silicon steel alloy composition;
aluminum present in an amount of from about 0.4 parts by weight to about 0.55 parts by weight based on 100 parts by weight of the silicon steel alloy composition;
titanium present in an amount of less than or equal to about 0.02 parts by weight based on 100 parts by weight of the silicon steel alloy composition;
vanadium present in an amount of less than or equal to about 0.002 parts by weight based on 100 parts by weight of the silicon steel alloy composition;
manganese present in an amount of from about 0.030 parts by weight to about 0.600 parts by weight based on 100 parts by weight of the silicon steel alloy composition;
phosphorus present in an amount of from about 0.002 parts by weight to about 0.020 parts by weight based on 100 parts by weight of the silicon steel alloy composition;
nickel present in an amount of from about 0.002 parts by weight to about 0.060 parts by weight based on 100 parts by weight of the silicon steel alloy composition;
chromium present in an amount of from about 0.006 parts by weight to about 0.090 parts by weight based on 100 parts by weight of the silicon steel alloy composition;
molybdenum present in an amount of from about 0.003 parts by weight to about 0.015 parts by weight based on 100 parts by weight of the silicon steel alloy composition;
copper present in an amount of from about 0.003 parts by weight to about 0.09 parts by weight based on 100 parts by weight of the silicon steel alloy composition;
tin present in an amount of from about 0.001 parts by weight to about 0.050 parts by weight based on 100 parts by weight of the silicon steel alloy composition;
boron present in an amount of from about 0.0001 parts by weight to about 0.004 parts by weight based on 100 parts by weight of the silicon steel alloy composition;
tungsten present in an amount of less than or equal to about 0.001 parts by weight based on 100 parts by weight of the silicon steel alloy composition;
sulfur present in an amount of from about 0.002 parts by weight to about 0.009 parts by weight based on 100 parts by weight of the silicon steel alloy composition;
oxygen present in an amount of from about 0.001 parts by weight to about 0.040 parts by weight based on 100 parts by weight of the silicon steel alloy composition; and
nitrogen present in an amount of from about 0.002 parts by weight to about 0.010 parts by weight based on 100 parts by weight of the silicon steel alloy composition.

13. A silicon steel sheet system comprising:
a silicon steel sheet formed from a silicon steel alloy composition, wherein said silicon steel alloy composition includes;
iron;
carbon present in an amount of from about 0.002 parts by weight to about 0.06 parts by weight based on 100 parts by weight of said silicon steel alloy composition;
silicon present in an amount of from about 1.5 parts by weight to about 4.0 parts by weight based on 100 parts by weight of said silicon steel alloy composition;
aluminum present in an amount of from about 0.1 parts by weight to about 1.0 part by weight based on 100 parts by weight of said silicon steel alloy composition;
titanium present in an amount of less than or equal to about 0.03 parts by weight based on 100 parts by weight of said silicon steel alloy composition;
vanadium present in an amount of less than or equal to about 0.005 parts by weight based on 100 parts by weight of said silicon steel alloy composition; and
cobalt present in an amount of from about 0.001 parts by weight to about 5.0 parts by weight based on 100 parts by weight of said silicon steel alloy composition;
wherein neither niobium nor zirconium is present in said silicon steel alloy composition; and
a coating disposed on said silicon steel sheet.

14. The silicon steel sheet system of claim 13, wherein said coating has a thickness of from about 0.2 microns to about 0.5 microns.

15. The silicon steel sheet system of claim 13, wherein said silicon steel alloy composition further includes;
carbon present in an amount of from about 0.004 parts by weight to about 0.008 parts by weight based on 100 parts by weight of said silicon steel alloy composition;
silicon present in an amount of from about 2.0 parts by weight to about 3.5 parts by weight based on 100 parts by weight of said silicon steel alloy composition;
aluminum present in an amount of from about 0.4 parts by weight to about 0.55 parts by weight based on 100 parts by weight of said silicon steel alloy composition;
titanium present in an amount of less than or equal to about 0.02 parts by weight based on 100 parts by weight of said silicon steel alloy composition;
vanadium present in an amount of less than or equal to about 0.002 parts by weight based on 100 parts by weight of said silicon steel alloy composition;
manganese present in an amount of from about 0.030 parts by weight to about 0.600 parts by weight based on 100 parts by weight of said silicon steel alloy composition;
phosphorus present in an amount of from about 0.002 parts by weight to about 0.020 parts by weight based on 100 parts by weight of said silicon steel alloy composition;
nickel present in an amount of from about 0.002 parts by weight to about 0.060 parts by weight based on 100 parts by weight of said silicon steel alloy composition;
chromium present in an amount of from about 0.006 parts by weight to about 0.090 parts by weight based on 100 parts by weight of said silicon steel alloy composition;
molybdenum present in an amount of from about 0.003 parts by weight to about 0.015 parts by weight based on 100 parts by weight of said silicon steel alloy composition;
copper present in an amount of from about 0.003 parts by weight to about 0.09 parts by weight based on 100 parts by weight of said silicon steel alloy composition;
tin present in an amount of from about 0.001 parts by weight to about 0.050 parts by weight based on 100 parts by weight of said silicon steel alloy composition;
boron present in an amount of from about 0.0001 parts by weight to about 0.004 parts by weight based on 100 parts by weight of said silicon steel alloy composition;
tungsten present in an amount of less than or equal to about 0.001 parts by weight based on 100 parts by weight of said silicon steel alloy composition;
sulfur present in an amount of from about 0.002 parts by weight to about 0.009 parts by weight based on 100 parts by weight of said silicon steel alloy composition;
oxygen present in an amount of from about 0.001 parts by weight to about 0.040 parts by weight based on 100 parts by weight of said silicon steel alloy composition; and
nitrogen present in an amount of from about 0.002 parts by weight to about 0.010 parts by weight based on 100 parts by weight of said silicon steel alloy composition.

16. An electromagnetic machine comprising:
a magnetic component including a plurality of silicon steel sheets stacked adjacent one another, wherein each of said plurality of silicon steel sheets is formed from a silicon steel alloy composition including;
iron;
carbon present in an amount of from about 0.002 parts by weight to about 0.06 parts by weight based on 100 parts by weight of said silicon steel alloy composition;
silicon present in an amount of from about 1.5 parts by weight to about 4.0 parts by weight based on 100 parts by weight of said silicon steel alloy composition;
aluminum present in an amount of from about 0.1 parts by weight to about 1.0 part by weight based on 100 parts by weight of said silicon steel alloy composition;
titanium present in an amount of less than or equal to about 0.03 parts by weight based on 100 parts by weight of said silicon steel alloy composition;
vanadium present in an amount of less than or equal to about 0.005 parts by weight based on 100 parts by weight of said silicon steel alloy composition; and
cobalt present in an amount of from about 0.001 parts by weight to about 5.0 parts by weight based on 100 parts by weight of said silicon steel alloy composition;
wherein neither niobium nor zirconium is present in said silicon steel alloy composition.

17. The electromagnetic machine of claim 16, wherein said silicon steel alloy composition further includes;
titanium present in an amount of less than or equal to about 0.02 parts by weight based on 100 parts by weight of said silicon steel alloy composition;
vanadium present in an amount of less than or equal to about 0.002 parts by weight based on 100 parts by weight of said silicon steel alloy composition;
aluminum present in an amount of from about 0.4 parts by weight to about 0.55 parts by weight based on 100 parts by weight of said silicon steel alloy composition;
manganese present in an amount of from about 0.030 parts by weight to about 0.600 parts by weight based on 100 parts by weight of said silicon steel alloy composition;
phosphorus present in an amount of from about 0.002 parts by weight to about 0.020 parts by weight based on 100 parts by weight of said silicon steel alloy composition;
nickel present in an amount of from about 0.002 parts by weight to about 0.060 parts by weight based on 100 parts by weight of said silicon steel alloy composition;
chromium present in an amount of from about 0.006 parts by weight to about 0.090 parts by weight based on 100 parts by weight of said silicon steel alloy composition;
molybdenum present in an amount of from about 0.003 parts by weight to about 0.015 parts by weight based on 100 parts by weight of said silicon steel alloy composition;
copper present in an amount of from about 0.003 parts by weight to about 0.09 parts by weight based on 100 parts by weight of said silicon steel alloy composition;
tin present in an amount of from about 0.001 parts by weight to about 0.050 parts by weight based on 100 parts by weight of said silicon steel alloy composition;
boron present in an amount of from about 0.0001 parts by weight to about 0.004 parts by weight based on 100 parts by weight of said silicon steel alloy composition; and
tungsten present in an amount of less than or equal to about 0.001 parts by weight based on 100 parts by weight of said silicon steel alloy composition.

18. The electromagnetic machine of claim 16, wherein said magnetic component is a rotor.
